(19) United States
(12) Patent Application Publication
(10) Pub. No.: US 2002/0091218 A1
(43) Pub. Date: Jul. 11, 2002

(54) Thermoplastic door skins and method of manufacture thereof

(76) Inventors: David Ford, Lee's Summit, MO (US); Kevin Rudolph, Overland Park, KS (US)

Correspondence Address: SHUGHART THOMSON & KILROY, PC, 120 WEST 12TH STREET, KANSAS CITY, MO, 64105, US

(21) Appl. No.: 09/756,477

(22) Filed: Jan. 8, 2001

(51) Int. Cl. C08L 1/00

(52) U.S. Cl. 526/351

(57) ABSTRACT

Door skins for a door skin assembly are formed from thermoplastic material in a thermoplastic flow forming process. The thermoplastic material is a composite material including polypropylene copolymer, glass fiber, UV stabilizers, filler such as talc and pigment.

### BACKGROUND OF THE INVENTION

The present invention relates to materials for forming door skins for use in manufacturing doors and the process for forming the door skins.

Doors are increasingly being manufactured from plastic components. Typical door assemblies comprise a pair of compression molded exterior skins, having wood grain patterns on their outer surfaces, which are mounted on a rectangular frame which separates and supports the skins in spaced apart relationship. The hollow space between the skins is filled with foam, such as a polyurethane foam. These composite door assemblies resist rot or corrosion and are generally better insulators than wood or metal doors. Because of material costs and manufacturing efficiencies, composite door assemblies are considerably less expensive to manufacture than wood doors and can be designed to provide a reasonable facsimile of a wood grain door.

The compression molding process utilized in manufacturing currently available door assembly skins does have limitations which effect the efficiency of the molding process and place limitations on the design of the skins. A typical compression molding process involves manually placing a first rectangular sheet of a thermosetting resin within a lower mold half corresponding to the shape of the outer surface of the door skin. A sheet of reinforcing material, typically a fiberglass mat, is placed on top of the first sheet of thermosetting resin and then a second sheet of thermosetting resin is placed on top of the fiberglass mat. An upper mold half is then advanced into engagement with the lower mold half to compress the layered materials therebetween and the mold is heated to cause the layers of thermosetting resin to melt, disperse through or bond with the reinforcing material and to conform to the shape of the mold. Further compression and heating of the mold and subsequent cooling thereof causes the thermosetting material to set in the molded shape. After setting, the thermosetting process generally cannot be reversed and any finished material which is flawed, scrapped or otherwise rejected must be disposed of typically in an expensive controlled landfill.

In a simple compression molding process as described above, the resulting molded structure including structural elements molded therein must be of a relatively consistent thickness. The addition of relatively thicker structural elements in the door skin or the addition of structural elements which require the displacement of a considerable amount of molding material away from the face of the door skin require the use of secondary molding steps to build up the structural element. Such secondary molding steps significantly add to the molding cost and the cost of the finished product.

Thermoplastics can be reused and it is known that a molded part of varying thickness can be produced in a closed injection molding process. However, due to cost considerations, a closed injection molding process is generally impractical for the commercial production of door skins.

There remains a need for improved door skin designs which facilitate assembly of the door skins and reduce manufacturing costs. Although others have discussed the possibility of thermoplastic door skins, to applicant's knowledge no one has successfully produced a thermoplastic door skin. In particular, U.S. Pat. No. 5,644,870 mentions that the door skins disclosed therein can be formed from thermoplastic material, but the disclosure is not enabling for use of thermoplastic materials.

### SUMMARY OF THE INVENTION

The present invention comprises a composite door assembly including door skins which are formed from thermoplastic material. In a preferred embodiment, the thermoplastic material used to form the door skin is a polypropylene copolymer resin. Additives including reinforcing glass fiber strands, fillers such as talc, a UV stabilizer such as a benzotriazole and pigment are also utilized in combination with the thermoplastic material. The door skins are formed in a thermoplastic flow forming process wherein the molten thermoplastic molding material including additives flows from a flow controlled die onto a lower mold half for the skin which is moving below the die. The flow of molten molding material through the die is controlled such that the amount of molding material laid down in a particular area of the mold generally corresponds to the desired thickness of the portion of the molded part at that area. After the lower mold half is filled, it is advanced to a press and an upper mold half is advanced into engagement with the lower mold half to form the door skin therebetween. After cooling, the mold halves are separated and the molded skin is ejected.

### BRIEF DESCRIPTION OF THE DRAWINGS

FIG. 1 is a front plan view of a door assembly.

FIG. 2 is an enlarged and fragmentary cross-sectional view taken along line 2-2 of FIG. 1.

FIG. 3 is an enlarged and fragmentary top plan view of the door assembly as in FIG. 1.

FIG. 4 is an enlarged and fragmentary front plan view of a rear skin of the door assembly.

FIG. 5 is an enlarged and fragmentary front perspective view of the rear skin of the door assembly.

FIG. 6 is an enlarged and fragmentary cross-sectional view taken along line 6-6 of FIG. 1.

FIG. 7 is an exploded perspective view of the door assembly without a layer of foam injected between the front and rear skins.

FIG. 8 is a schematic diagram of a thermoplastic flow forming process by which skins of the door assembly are produced.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural,compositional and functional details disclosed herein are not to be interpreted as limiting, but merely as a basis for the claims and as a representative basis for teaching one skilled in the art to variously employ the present invention in virtually any appropriately detailed structure, composition or process.

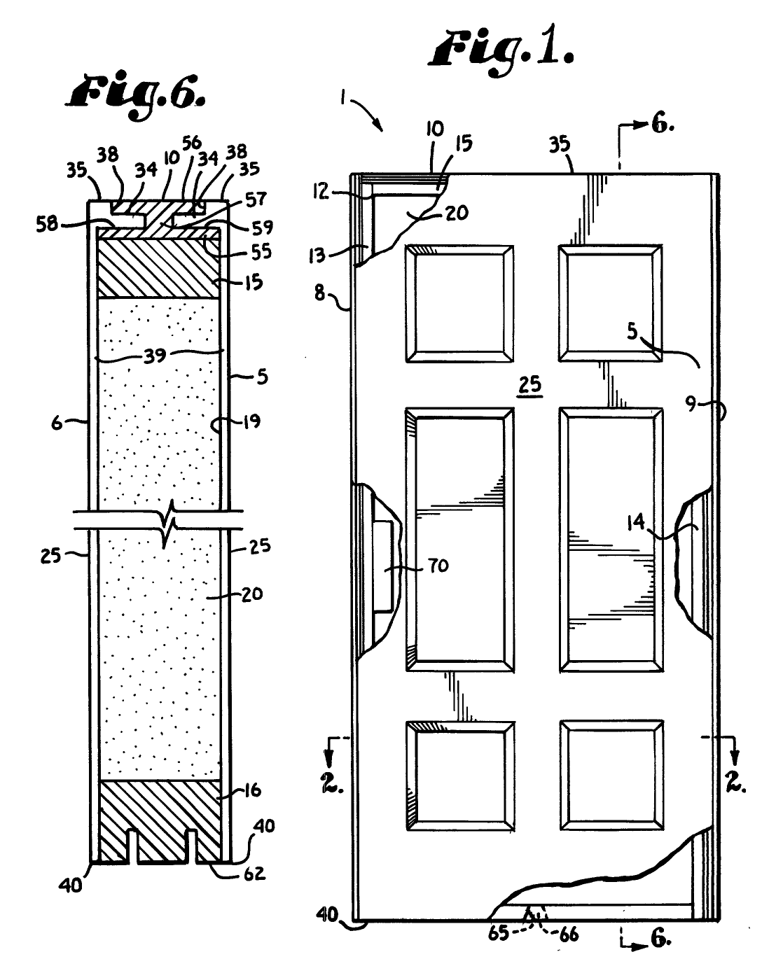

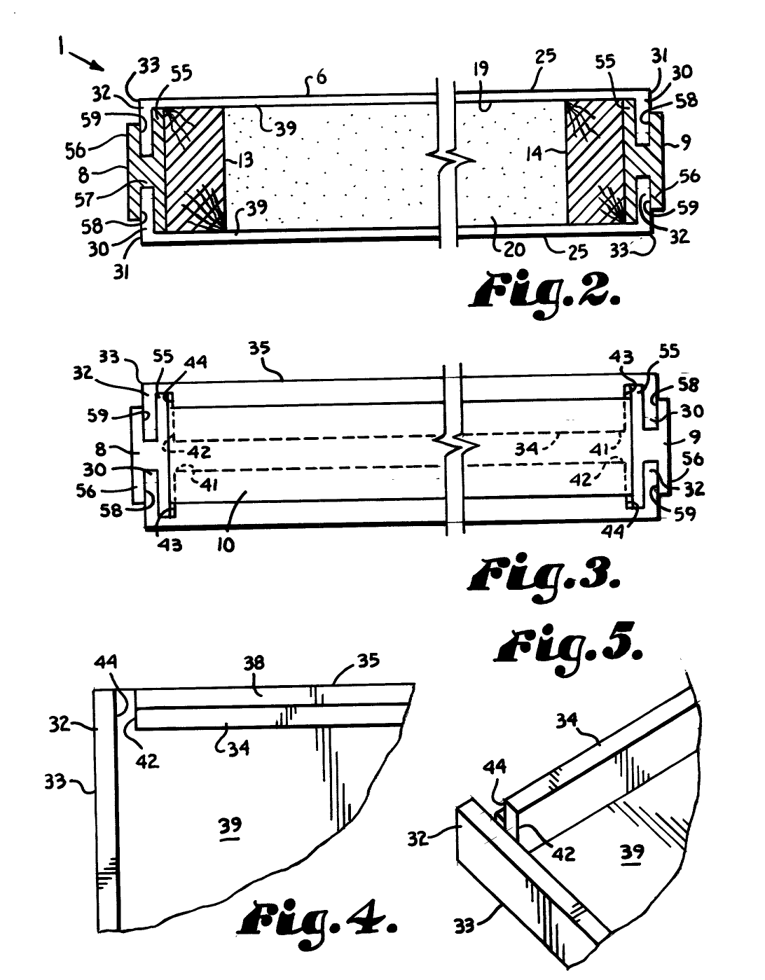

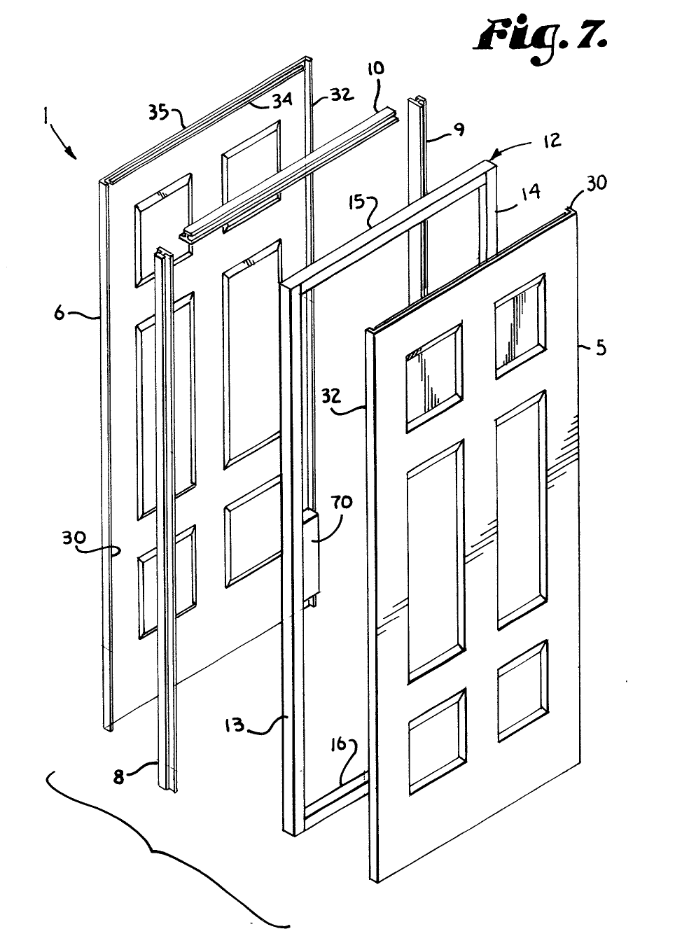

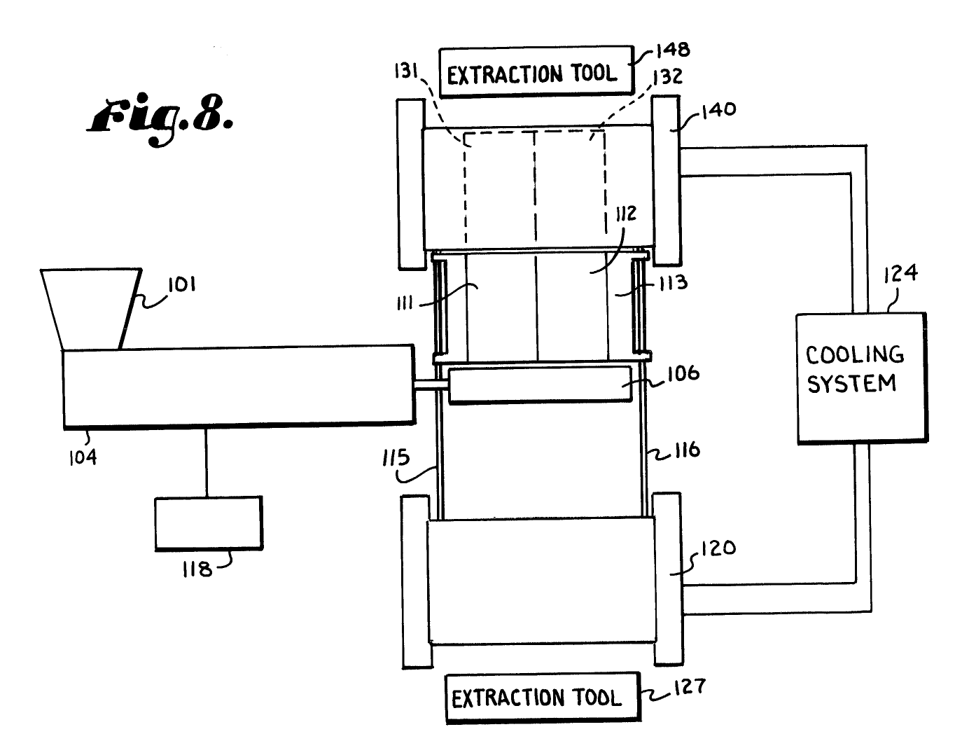

Referring to the drawings in more detail, the reference numeral 1 refers to a door assembly. As generally shown in FIGS. 1 through 6, the door assembly 1 comprises a pair of opposed or front and rear door panels or skins 5 and 6. The door assembly 1 is an example of the type in which the components, including skins 5 and 6 may be formed using thermoplastic material and formed using a thermoplastic flow forming process.

### Door Skin Assembly Construction

The front and rear skins 5 and 6 are connected together by connectors 8, 9 and 10 and mounted on frame 12. Frame 12 comprises first and second stiles 13 and 14, top rail 15 and bottom rail 16. The interior space 19 between the skins 5 and 6 is filled with a polyurethane foam 20 which is injected therein after assembly of the skins 5 and 6, with connectors 8, 9 and 10 on the stiles 13 and 14 and top rail 15 of frame 12. The bottom rail 16 is inserted and secured between lower ends of stiles 13 and 14 after injection of polyurethane foam 20 within the interior space 19.

Skins 5 and 6 are identical in construction. An outer or exterior surface 25 of each skin 5 and 6 is textured during the molding process to imitate a wood grain texture. A tongue is formed on an inner surface 27 of each skin 5 and 6 and extends around the outer periphery of the sides and the top thereof. In particular, a first side tongue 30 extends along a first side edge 31 of each of the skins 5 and 6, a second side tongue 32 extends along a second side edge 33 of each of the skins 5 and 6, and a top tongue 34 extends along a top edge 35 of each of the skins 5 and 6.

Outer surfaces of the first side tongue 30 and the second side tongue 32 extend flush with the first side edge 31 and the second side edge 33 respectively. The top tongue 34 is spaced inward from the top edge 35 of each of the skins 5 and 6 so as to form a top lip or shoulder 38 extending outward from or above the top tongue 34. The interior portion 39 of each skin 5 and 6 is of a relatively thin and uniform thickness. For illustrative purposes, the interior portion 43 of each skin 5 and 6 is approximately 0.085 inches thick. The first side, second side and top tongues 30, 32 and 33 extend rearward from the inner surface 27 of the skins 5 and 6 approximately 0.54 inches and are approximately 0.187 inches thick or at least twice as thick as the interior portion 43 of the skins 5 and 6. The top tongue 34 is spaced inward from the top edge 35 approximately 0.187 inches by top lip or shoulder 38 which is approximately 0.250 inches thick.

The first side tongue 30 and the second side tongue 32 extend from the top edge 35 of each skin 5 and 6 to a bottom edge 40 thereof. First and second ends 41 and 42 of the third or top tongue 34 are spaced apart from the first and second side tongues 30 and 32 respectively by first side and second side channels 43 and 44.

Opposed skins 5 and 6 are connected together using two side connectors 8 and 9 and top connector 10. The connectors 8, 9 and 10 are of an identical H-shaped cross-section and preferably formed from a single extrusion cut to the desired lengths. The side connectors 8 and 9 are of identical length, equal to the length of the first and second tongue sections 30 and 32. The top connector 10 is shorter than the side connectors 8 and 9 and slightly longer than the top tongue 34, as discussed in more detail below.

Each of the connectors 8, 9 and 10 includes inner and outer walls 55 and 56 connected together medially by cross-member or web 57, so as to form first and second tongue receiving grooves 58 and 59 extending longitudinally between the inner and outer walls 55 and 56. The grooves 58 and 59 are sized to mate with the tongue sections 30, 32 and 34. The width of the grooves 58 and 59 corresponds to the width of the tongue sections 30, 32 and 34, which in the embodiment as noted above is approximately 0.187 inches. The outer wall 56 is approximately 0.187 inches thick which is approximately at least as thick as most door hinge leaves to permit portions of the outer wall 56 to be removed to form a recess for receiving a hinge leaf without having to cut into the skins 5 or 6 themselves. The inner wall 55 is slightly narrower to conserve material.

The corners of the connectors 8, 9 and 10 which engage portions of the tongues 30, 32 and 34 and the corresponding corners of the tongues 30, 32 and 34 are radiused to provide additional strength at the corners.

The skins 5 and 6 are connected together by first placing connectors 8, 9 and 10 on first side tongue 30, second side tongue 32 and top tongue 34 respectively of first skin 5 such that the tongues 30, 32 and 34 extend into the first tongue receiving grooves 58 of connectors 8, 9 and 10 respectively. Upper ends of side connectors 8 and 9 extend through the first and second side channels 43 and 44 respectively between the first side and second side tongues 30 and 32 and the top tongue 34 respectively. The channels 43 and 44 are slightly wider than the inner walls 55 of each connector 8 and 9 to ensure that the upper ends of the connectors 89 may pass therethrough without binding. The top connector 10 is sized to completely span the distance between interior surfaces of the inner walls 55 of the connectors 8 and 9.

An adhesive is applied to the tongues 30, 32 and 34 or within the first tongue receiving grooves 58 prior to attachment of the connectors 8, 9 and 10 to tongues 30, 32 and 34. The frame 12 is then secured to the first skin 5. In particular, the first and second stiles 13 and 14, top rail 15 and bottom rail 16 are positioned against the inner surface 27 of the first skin 5 such that the first and second stiles 13 and 14 abut against the inner walls 55 of side connectors 8 and 9 and top rail 15 abuts against the inner wall 55 of top connector 10. An adhesive is applied to the frame components to secure the stiles 13 and 14 and top rail 15 to the skin 5 and connectors 8, 9 and 10 respectively and to secure the bottom rail 16 to skin 5. The bottom rail 16 is generally positioned such that a bottom edge 62 of the bottom rail 16 generally extends flush with the bottom edge 40 of the skin 5. It is foreseen that the frame 12 may be assembled prior to attachment to the skin 5.

The rear skin 6 is then secured in place by inserting first side, second side and top tongues 30, 32 and 34 of skin 6 in the second tongue receiving grooves 59 of connectors 9, 8 and 10 respectively. The tongues 30, 32 and 34 are secured within the second tongue receiving grooves 59 by gluing. The bottom rail 16 may also be glued to inner surfaces 27 of the front and rear skins 5 and 6.

The skins 5 and 6, with the frame positioned therein, are held together in a jig (not shown) and polyurethane foam 20 is injected into the interior space 19 between the skins 5 and 6 through a nozzle (not shown) inserted through a hole 65 in the bottom rail 16. After the foam 20 is injected between the skins 5 and 6 a plug 66 is inserted into the hole 65 and glued to the bottom rail 16 to seal off the hole 65.

A lock block 70 is formed on first stile 13 to provide structure into which a hole for a knob may be bored and to which a knob (not shown) may be secured. It is to be understood that the second stile 14 is sufficiently thick, to receive screws (not shown) for securing hinges (not shown) thereto.

When the door assembly 1 is assembled, the outer walls 56 of side connectors 8 and 9 extend beyond the first and second side edges 31 and 33 of the skins 5 and 6, while the outer wall 56 of top connector 10 extends flush with the top edge 35 of the skins 5 and 6. Portions of the outer walls 56 of the side connector 9 are typically cut away to form recesses into which a leaf from a door hinge (not shown) may be positioned. Portions of the outer walls 56 of the side connectors 8 and 9 may be trimmed to ensure a proper fit of the door assembly 1 within a door jamb. Similarly the bottom rail 16 is adapted to permit trimming thereof to ensure a proper fit of the door.

It is foreseen that the first side and second side tongues 30 and 32 could also be spaced inward from the first and second side edges 31 and 33 similar to the top tongue 34, such that the outer walls 56 of side connectors 8 and 9 extend flush with the first and second side edges 31 and 33 of the skins 5 and 6 when assembled.

The stiles 13 and 14 and top rail 15 can be formed from thermoplastic material but are preferably formed from wood which provides a desired rigidity for the assembled door. Further, wood of the quality and type suitable for use in forming the stiles 13 and 14 and top rail 15 is generally readily available and relatively inexpensive. Further, door assemblers are familiar with and have the tools necessary for constructing and handling wooden frames 12. It is foreseen that the frame components could also be formed from thermoplastic material or other suitable materials.

### Thermoplastic Molding Materials

As noted above, the skins 5 and 6 are formed from a composite molding material comprising a thermoplastic material in combination with additives, reinforcing fibers and/or fillers. A preferred composite molding material comprises, by weight percent, 66-67% polypropylene copolymer resin, 15% glass fiber strands 4 mm (0.16 inches) long and 0.0035 mm (0.00014 inches) in diameter, 15% talc, 1-2% UV stabilizer (such as a benzotriazole) and 2-3% pigment. The concentrations provided are approximations and it is to be understood that a wide variety of concentrations may be utilized. In particular, it is foreseen that the concentration of polypropylene could range from approximately 50% to approximately 100%. However, in most applications a concentration of glass fibers of at least 10% would be preferred along with additional additives, such that the preferred range for the concentration of polypropylene would range from 50% to 85%. It is foreseen that the concentration of glass fibers would preferably range from 10% to 20%.

Another composite thermoplastic material might comprise approximately eighty percent (80%) by weight high impact polystyrene with (20%) twenty percent by weight wood fiber. Other thermoplastics which might be utilized include; acrylonitrile-butadiene-styrene, acetal, nylon, polyester, polypropylene, polyethylene, polyvinyl chloride and acrylic.

The talc is used as a filler and its ability to add rigidity and stiffness and for thermal stability. Other fillers which could be utilized include calcium carbonate and cellulose such as the wood fiber noted above. Although glass fibers are disclosed as the reinforcing fibers it is foreseen that other fibers including carbon fibers could be utilized. Similarly, a wide The connectors 8, 9 and 10 are preferably also formed from the composite molding material in an extrusion process.

In the preferred embodiment, the connectors 8, 9 and 10 are formed separate from the stiles 13 and 14 and top rail 15 respectively. However it is foreseen that the connectors 8, 9 and 10 could be integrally formed with the stiles 13 and 14 and the top rail 15 such that the stiles 13, 14 and 15 incorporate the connectors 8, 9 and 10 respectively.

### Method of Manufacturing Door Skins

The skins 5 and 6 are formed from the composite molding material using a thermoplastic flow forming process. A process diagram is shown in FIG. 8. In the preferred embodiment, the polypropylene is usually provided in pellet form, the talc and the UV stabilizer as a powder and the pigment in either pellet or powder form.

The original ingredients are fed in dry form into a mixing hopper 101 mounted opposite the output end of an extruder 104. The hopper 101 is of a type which weighs each component independently, mixes the components and gravimetrically feeds it into the extruder 104. The extruder melts the composite thermoplastic material and ejects the molten molding material into a sheet die 106.

Molten molding material flows out of the die 106 through an outlet 107 (not shown). Molten molding material flows out of the outlet 107 into a first pair of lower or first mold halves 111 and 112 as the lower mold halves 111 and 112 are advanced beneath the outlet 107 to the sheet die 106. The first pair of lower mold halves 111 and 112 are supported in side by side relationship on a first trolley 113 which is moveably mounted on rails 115 and 116 which extend transverse to the sheet die outlet 107. The outlet 107 is approximately as wide as the distance across the first pair of lower mold halves 111 and 112. Each of the lower mold halves 111 and 112 is shaped to form a first side or face of a door skin, such as skins 5 or 6.

The molten molding material flows into the lower mold halves 111 and 112 generally as a sheet as the mold halves 110 and 111 pass therebeneath on trolley 113. The size and shape of the outlet 107 and the flowrate of molding material through the die 106 is controlled by a computer control system 118 such that the amount of molding material flowing into a particular area of a lower mold half 111 or 112 generally corresponds to the amount of material necessary to achieve the desired thickness of the molded part in that area.

The lower mold halves 111 and 112 are then advanced on the first trolley 13 into a first compression press 120 and below a first pair of adjacently aligned upper mold halves 121 and 122 (not shown) already positioned in the compression press 120. The upper mold halves 121 and 122 are then advanced into engagement with the lower mold halves 111 and 112 and the molding material is compressed therebetween expelling any air trapped therebetween and allowing the molten material to fill out and conform to the shape of a molding cavity formed between the upper mold halves 121 and 122 and the lower mold halves 111 and 112.

Cooling water, from a cooling system 124 is circulated through or around the mold halves 111 and 112 and 121 and 122 to cool the molded part or door skin 125 formed therebetween. Once sufficient time elapses to permit adequate cooling, the mold halves 111 and 112 and 121 and 122 are separated in the compression press 120 and the door skins are removed from between the upper mold halves 121 and 122 and the lower mold halves 111 and 112 by a vacuum extration tool 127.

A second pair of lower mold halves 131 and 132 are secured on a second trolley 133 (not shown) which is moveably mounted on rails 115 and 116. When the first trolley 113 is in the first compression press 120, the second trolley 133 is advanced beneath the sheet die 106 and molten molding material flows through the outlet 107 thereof into the second pair of lower mold halves 131 and 132. The second trolley 133 beneath the sheet die 106 in a direction opposite to which the first trolley 113 passes beneath the die 106. After the second pair of lower mold halves 131 and 132 pass completely beneath the sheet die 106, they are advanced on the second trolley 133 into a second compression press 140 and beneath a second pair of adjacently aligned upper mold halves 141 and 142 (not shown). The second compression press 140 is positioned on a side of the sheet die 106 opposite the first compression press 120. The second pair of upper mold halves 141 and 142 are then advanced into engagement with the second pair of lower mold halves 131 and 132 and the molding material is compressed therebetween expelling any air trapped therebetween and allowing the molten material to fill out and conform to the shape of a molding cavity formed between the upper mold halves 141 and 142 and the lower mold halves 131 and 132.

Cooling water, from the cooling system 124, is circulated through or around the mold halves 131 and 132 and 141 and 142 to cool the molded part or door skin 125 formed therebetween. Once sufficient time elapses to permit adequate cooling, the mold halves 131 and 132 and 141 and 142 are separated in the compression press 140 and the door skins are removed from between the upper mold halves 141 and 142 and the lower mold halves 131 and 132 by a second vacuum extration tool 148.

As the second pair of upper and lower mold halves 141 and 142 and 131 and 132 are being compressed and separated in the second compression press 140, the first trolley 113 is advanced out of the first compression press 120 past and then back under the sheet die 106 toward the first compression press 120 such that one pair of lower mold halves 111 and 112 or 131 and 132 is being filled while the other set is in the associated compression press 120 or 140. The movement of the trolleys 113 and 133 is controlled by the computer control system 118.

If the resulting door skin or molded part 125 is flawed, the skin may be ground into relatively small pieces which are fed back to the hopper 101 for reuse. Similarly, any excess molding material purged or trimmed from between the upper and lower mold halves may be ground and fed back to the hopper 101 for reuse.

It is to be understood that while certain forms of the present invention have been illustrated and described herein, it is not to be limited to the specific forms or arrangement of parts described and shown.

What is claimed and desired to be secured by letters patent is as follows:

1. A molded door skin formed from:
a) a thermoplastic material.

2. The molded door skin as in claim 1 wherein said thermoplastic material comprises polypropylyene.

3. The molded door skin as in claim 2 comprising approximately fifty to eighty five percent by weight polypropylene.

4. The molded door skin as in claim 3 further comprising approximately ten to twenty percent by weight glass fibers.

5. The molded door skin as in claim 2 comprising approximately sixty six percent by weight polypropylene and approximately fifteen percent by weight glass fiber.

6. The door skin as in claim 1 wherein said thermoplastic material comprises:
a) high impact polystyrene.

7. The door skin as in claim 6 comprising approximately eighty percent polystyrene and approximately twenty percent wood fiber.

8. A process for forming a door skin comprising the steps of:
a) providing a lower mold half shaped to form a first side of a door skin;
b) providing an upper mold half shaped to form a second side of a door skin;
c) advancing said first mold half beneath a source of molten thermoplastic;
d) allowing molten thermoplastic to flow from said source of molten thermoplastic into said first mold half;
e) controlling the flow of molten thermoplastic into said first mold half such that the quantity of molten thermoplastic flowing to any particular area of said first mold half corresponds to the thickness of the portion of the door skin to be formed at that particular area;
f) advancing said first mold half from below said source of molten thermoplastic;
g) advancing said second mold half into engagement with said first mold half forming the molten material deposited on said first mold half into the shape of a mold cavity formed between said first and second mold halves;
h) allowing said molten thermoplastic in said mold cavity to set;
i) advancing said second mold half away from said first mold half; and
j) ejecting said door skin from between said first and second mold halves.

9. The process for forming a door skin as in claim 8 wherein said thermoplastic material comprises polypropylene.

10. The process for forming a door skin as in claim 8 wherein said thermoplastic material comprises approximately fifty to eighty five percent by weight polypropylene.

11. The process for forming a door skin as in claim 10 further comprising approximately ten to twenty percent by weight glass fibers.

12. The process for forming a door skin as in claim 9 wherein said source of molten thermoplastic material comprises an extruder and the step of allowing molten thermoplastic to flow from said source of molten thermoplastic into said first mold half includes a previous step of feeding said polypropylene and glass fiber from a hopper into said extruder which melts said polypropylene.
